(19) United States
(12) Patent Application Publication
(10) Pub. No.: US 2021/0207747 A1
(43) Pub. Date: Jul. 8, 2021

(54) RE-DEPLOYABLE PIPE FITTING SYSTEMS AND METHODS

(71) Applicant: Trinity Bay Equipment Holdings, LLC, Houston, TX (US)

(72) Inventor: David Michael Gregory, Houston, TX (US)

(21) Appl. No.: 16/736,465

(22) Filed: Jan. 7, 2020

(51) Int. Cl. F16L 15/00; F16L 15/04

(52) U.S. Cl. CPC F16L 15/008; F16L 15/04; F16L 15/005

(57) ABSTRACT

Techniques for implementing a pipeline system that includes one or more pipe segments, in which each pipe segment of the one or more pipe segments includes tubing that defines a pipe bore and a fluid conduit implemented in an annulus of the tubing, and a re-deployable pipe fitting to be secured to the one or more pipe segments. The re-deployable pipe fitting includes a fitting body that defines a fitting bore through the re-deployable pipe fitting and a threaded fitting jacket to be deformed around the tubing of a pipe segment of the one or more pipe segments to facilitate securing the re-deployable pipe fitting to the pipe segment. The threaded fitting jacket includes jacket threading that enables the threaded fitting jacket to be coupled to the fitting body, removed from the fitting body, or both without using hot tooling.

### BACKGROUND

The present disclosure generally relates to pipeline systems and, more particularly, to pipe fittings that may be re-deployable (e.g., reusable) in pipeline systems.

Pipeline systems are often implemented and/or operated to facilitate transporting (e.g., conveying) fluid, such as liquid and/or gas, from a fluid source to a fluid destination. For example, a pipeline system may be used to transport one or more hydrocarbons, such as crude oil, petroleum, natural gas, or any combination thereof. Additionally or alternatively, a pipeline system may be used to transport one or more other types of fluid, such as produced water, fresh water, fracturing fluid, flowback fluid, carbon dioxide, or any combination thereof.

To facilitate transporting fluid, a pipeline system may include one or more pipe segments in addition to pipe fittings (e.g., connectors), such as a midline pipe fitting and/or a pipe end fitting. Generally, a pipe segment may include tubing, which defines (e.g., encloses) a bore that provides a primary fluid conveyance (e.g., flow) path through the pipe segment. Additionally, one or more pipe fitting may generally be secured to a pipe segment to facilitate fluidly coupling the pipe segment to another pipe segment, a fluid source, and/or a fluid destination.

In particular, in some instances, a pipe fitting may be secured to a pipe segment via swaging techniques that conformally deform at least a portion of the pipe fitting around the tubing of the pipe segment. However, at least in some such instances, the deformation on the pipe fitting due to swaging may limit the ability of the pipe fitting to be removed from the pipe segment and re-deployed (e.g., re-used) at another pipe segment, for example, due to the conformal deformation resulting in the pipe fitting effectively being permanently coupled to the pipe segment and/or the inner surface diameter of the deformed portion of the pipe fitting being less than the outer surface diameter of the other pipe segment. In other words, in some instances, a pipe fitting that is secured using swaging techniques may effectively be a one-time-use pipe fitting and, thus, deploying the pipe fitting in a pipeline system may potentially limit deployment efficiency, for example, due to a change in deployment (e.g., layout and/or configuration) of the pipeline system resulting in an increased number of new (e.g., not previously swaged) pipe fittings being deployed therein.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one embodiment, a pipeline system includes one or more pipe segments, in which each pipe segment of the one or more pipe segments includes tubing that defines a pipe bore and a fluid conduit implemented in an annulus of the tubing, and a re-deployable pipe fitting to be secured to the one or more pipe segments. The re-deployable pipe fitting includes a fitting body that defines a fitting bore through the re-deployable pipe fitting and a threaded fitting jacket to be deformed around the tubing of a pipe segment of the one or more pipe segments to facilitate securing the re-deployable pipe fitting to the pipe segment. The threaded fitting jacket includes jacket threading that enables the threaded fitting jacket to be coupled to the fitting body, removed from the fitting body, or both without using hot tooling.

In another embodiment, a method of implementing a pipeline system includes implementing a reusable fitting body of a pipe fitting to be secured to a pipe segment to define a fitting bore through the pipe fitting, implementing a fitting jacket that includes jacket threading, and coupling the fitting jacket to the reusable fitting body of the pipe fitting onsite in the pipeline system at least in part by matingly engaging the jacket threading on the fitting jacket with other threading of the pipe fitting to enable the pipe fitting to be secured to the pipe segment at least in part by conformally deforming the fitting jacket around tubing of the pipe segment.

In another embodiment, a pipe fitting includes a reusable fitting body, in which the reusable fitting body includes a fitting tube that defines a fitting bore to be fluidly coupled to a pipe bore defined by tubing of a pipe segment to be secured to the pipe fitting and a threaded grab ring, which includes body threading, implemented circumferentially around the fitting tube. The pipe fitting includes a threaded fitting jacket, which includes jacket threading that matingly engages the body threading on the threaded grab ring or other threading of the pipe fitting to enable the threaded fitting jacket to be connected to the reusable fitting body, disconnected from the reusable fitting body, or both at least in part by rotationally actuating a portion of the pipe fitting.

### BRIEF DESCRIPTION OF DRAWINGS

FIG. 1 is a block diagram of an example of a pipeline system including pipe segments and pipe fittings (e.g., connectors), in accordance with an embodiment of the present disclosure.

FIG. 2 is a side view of an example of a pipe segment of FIG. 1 that includes a bore defined by its tubing as well as fluid conduits implemented within an annulus of its tubing, in accordance with an embodiment of the present disclosure.

FIG. 3 is a perspective view of an example of the pipe segment of FIG. 2 with a helically shaped fluid conduit implemented within the annulus of its tubing, in accordance with an embodiment of the present disclosure.

FIG. 4 is a side cross-sectional view of an example of deployment equipment coupled to a pipe fitting and pipe segments of FIG. 1, in accordance with an embodiment of the present disclosure.

FIG. 5 is a flow diagram of an example of a process for securing a pipe fitting to a pipe segment, in accordance with an embodiment of the present disclosure.

FIG. 6 is a side cross-sectional view of an example of a re-deployable pipe fitting that includes a reusable fitting body and threaded fitting jackets, in accordance with an embodiment of the present disclosure.

FIG. 7 is a side cross-sectional view of another example of a re-deployable pipe fitting that includes a reusable fitting body and a threaded fitting jacket, in accordance with an embodiment of the present disclosure.

FIG. 8 is side cross-sectional view of another example of a portion of a re-deployable pipe fitting that includes a reusable fitting body and a threaded fitting jacket, in accordance with an embodiment of the present disclosure.

FIG. 9 is a flow diagram of an example of a process for implementing a re-deployable pipe fitting, in accordance with an embodiment of the present disclosure.

FIG. 10 is side cross-sectional view of another example of a portion of a re-deployable pipe fitting that includes a reusable fitting body and a threaded fitting jacket, in accordance with an embodiment of the present disclosure.

FIG. 11 is a flow diagram of an example of a process for reusing a re-deployable pipe fitting, in accordance with an embodiment of the present disclosure.

### DETAILED DESCRIPTION

One or more specific embodiments of the present disclosure will be described below with reference to the figures. As used herein, the term “coupled” or “coupled to” may indicate establishing either a direct or indirect connection and, thus, is not limited to either unless expressly referenced as such. The term “set” may refer to one or more items. Wherever possible, like or identical reference numerals are used in the figures to identify common or the same features. The figures are not necessarily to scale. In particular, certain features and/or certain views of the figures may be shown exaggerated in scale for purposes of clarification.

The present disclosure generally relates to pipeline systems that may be implemented and/or operated to transport (e.g., convey) fluid, such as liquid and/or gas, from a fluid source to a fluid destination. Generally, a pipeline system may include pipe fittings (e.g., connectors), such as a midline pipe fitting and/or a pipe end fitting, and one or more pipe segments, which each includes tubing that defines (e.g., encloses) a corresponding pipe bore. Additionally, one or more pipe fitting may generally be secured to a pipe segment to facilitate fluidly coupling the pipe segment to another pipe segment, a fluid source, and/or a fluid destination. Merely as an illustrative non-limiting example, a pipeline system may include a first pipe end fitting secured to a first pipe segment to facilitate fluidly coupling the first pipe segment to the fluid source, a midline pipe fitting secured between the first pipe segment and a second pipe segment to facilitate fluidly coupling the first pipe segment to the second pipe segment, and a second pipe end fitting secured to the second pipe segment to facilitate fluidly coupling the second pipe segment to the fluid destination.

In any case, to enable fluid flow therethrough, a pipe fitting generally includes a fitting bore, which is defined (e.g., enclosed) by its fitting body, for example, which includes a body tube and a grab ring implemented around the body tube. Additionally, in some instances, the pipe fitting may be secured to a pipe segment at least in part by securing the tubing of the pipe segment around its fitting body using swaging techniques. To facilitate securing a pipe segment thereto via swaging techniques, in some instances, the pipe fitting may include one or more fitting jackets implemented external to its fitting body. When implemented in this manner, the pipe fitting may be secured to the pipe fitting via swaging techniques at least in part by disposing (e.g., inserting) the tubing of the pipe segment in a tubing cavity of the pipe fitting, which is defined (e.g., enclosed) between a corresponding fitting jacket and the fitting body, and conformally deforming the fitting jacket around the pipe segment tubing, for example, using deployment equipment, such as a swage machine, coupled to the grab ring of the fitting body during field deployment.

In some instances, one or more fitting jackets of a pipe fitting may be integrated with its fitting body, for example, by milling the one or more fitting jackets and the fitting body from a single block of material, such as metal. Additionally or alternatively, one or more fitting jackets of a pipe fitting may be coupled to its fitting body using hot tooling, such as welding, for example, during initial manufacture of the pipe fitting. However, at least in some instances, hot tooling may generally be avoided during field deployment, for example, due at least in part to the hot tooling using high temperatures to melt one or more base materials of the fitting body and a fitting jacket.

In other words, once a pipe fitting is deployed in the field using swaging techniques, in some instances, the conformal deformation due to swaging may result in the pipe fitting effectively being permanently coupled to the pipe segment. Moreover, even when the pipe segment secured to the pipe fitting is removable from the pipe fitting, in some instances, the deformation of the pipe fitting due to swaging may limit the ability of the pipe fitting to be re-deployed in the field, for example, due to deformation of the pipe fitting resulting in an inner surface diameter of a fitting jacket being less than the default (e.g., natural, original, and/or uncompressed) outer surface diameter of another pipe segment deployed in the field. As such, at least in some instances, a pipe fitting that is implemented to be deployed (e.g., secured) using swaging techniques may effectively be a one-time-use pipe fitting and, thus, deploying the pipe fitting in a pipeline system may potentially limit deployment efficiency of the pipeline system, for example, due to a change in deployment (e.g., layout and/or configuration) of the pipeline system resulting in an increased number of new (e.g., not previously swaged) pipe fittings being deployed therein.

Accordingly, to facilitate improving pipeline deployment efficiency, the present disclosure provides techniques for implementing a pipe fitting that is at least partially re-deployable (e.g., reusable) in the field (e.g., onsite), for example, without hot tooling, such as welding, and/or re-processing the pipe fitting offsite (e.g., a manufacturing facility or plant). To facilitate field re-deployment, the re-deployable pipe fitting may include a reusable fitting body, which one or more threaded fitting jackets may be selectively coupled (e.g., connected) thereto and/or selectively removed (e.g., disconnected) therefrom. In other words, as will be described in more detail below, implementing a pipe fitting in this manner may enable different threaded fitting jackets to be selectively coupled to its reusable fitting body, for example, at different times and/or to accommodate different pipe segment tubing thicknesses.

Merely as an illustrative non-limiting example, in some embodiments, a threaded fitting jacket may include jacket threading implemented circumferentially along an inner surface of the threaded fitting jacket. More specifically, to enable the threaded fitting jacket to be selectively coupled to a reusable fitting body, the threading on the threaded fitting jacket may be implemented to matingly interface with body threading, which is implemented circumferentially along an outer surface of the reusable fitting body. In other words, in such embodiments, the threaded fitting jacket may be selectively coupled to the reusable fitting body at least in part engaging the jacket threading with the body threading and actuating (e.g., rotating) the threaded fitting jacket a first direction (e.g., clockwise) relative to the reusable fitting body. On the other hand, in such embodiments, the threaded fitting jacket may be selectively removed (e.g., disconnected) from the reusable fitting body at least in part by actuating the threaded fitting jacket in a second (e.g., counter-clockwise and/or opposite) direction relative to the reusable fitting body, for example, to enable a different (e.g., new and/or non-deformed) threaded fitting jacket to be coupled to the reusable fitting body in its place.

Additionally or alternatively, in some embodiments, a threaded fitting jacket may include one or more threaded openings, which are each implemented with jacket threading that runs circumferentially along an its inward-facing surface. To facilitate selectively coupling the threaded fitting jacket to a reusable fitting body, in such embodiments, the threaded opening may be implemented to align with a fastener opening, which extends through the reusable fitting body to enable a threaded end of a threaded fastener, such as bolt or a screw, to extend therethrough, and the jacket threading may be implemented to matingly interface with fastener threading on the threaded fastener. In other words, in such embodiments, the threaded fitting jacket may be selectively coupled to the reusable fitting body at least in part by aligning a threaded opening on the threaded fitting jacket with a fastener opening on the reusable fitting body, inserting a threaded fastener through the fastener opening such that its fastener head is on a first side of the reusable fitting body and its fastener threading extends through a second (e.g., opposite) side of the reusable fitting body to engage the jacket threading in the threaded opening of the threaded jacket, and actuating (e.g., rotating) the threaded fastener in a first direction (e.g., clockwise) relative to the threaded fitting jacket. On the other hand, in such embodiments, the threaded fitting jacket may be selectively removed from the reusable fitting body at least in part by actuating the threaded fastener in a second (e.g., counter-clockwise and/or opposite) direction relative to the threaded fitting jacket until its fastener threading disengages the jacket threading in the threaded opening of the threaded jacket, for example, to enable a different (e.g., new and/or non-deformed) threaded fitting jacket to be coupled to the reusable fitting body in its place.

In this manner, as will be described in more detail below, the techniques described in the present disclosure may facilitate implementing a pipe fitting that is at least partially reusable and/or re-deployable in a pipeline system, which, at least in some instances, may facilitate improving pipeline deployment efficiency, for example, due to reuse and/or re-deployment of the pipe fitting enabling a reduction in the number of new (e.g., not previously swaged) pipe fittings deployed therein. Merely as an illustrative non-limiting example, a pipe fitting may have been previously deployed in a pipeline system by securing the pipe fitting to a pipe segment via swaging techniques, which deformed a first threaded fitting jacket currently coupled to its reusable fitting body around the tubing of the pipe segment. When implemented in accordance with the techniques of the present disclosure, the pipe fitting may subsequently be re-deployed in the pipeline system or even a different pipeline system at least in part by coupling a second (e.g., new and/or non-deformed) threaded fitting jacket to the reusable fitting body in place of the first (e.g., deformed) threaded fitting jacket, thereby enabling pipe segment tubing to be reinserted into and, thus, secured in the pipe fitting, for example, instead of a completely new (e.g., not previous swaged) pipe fitting.

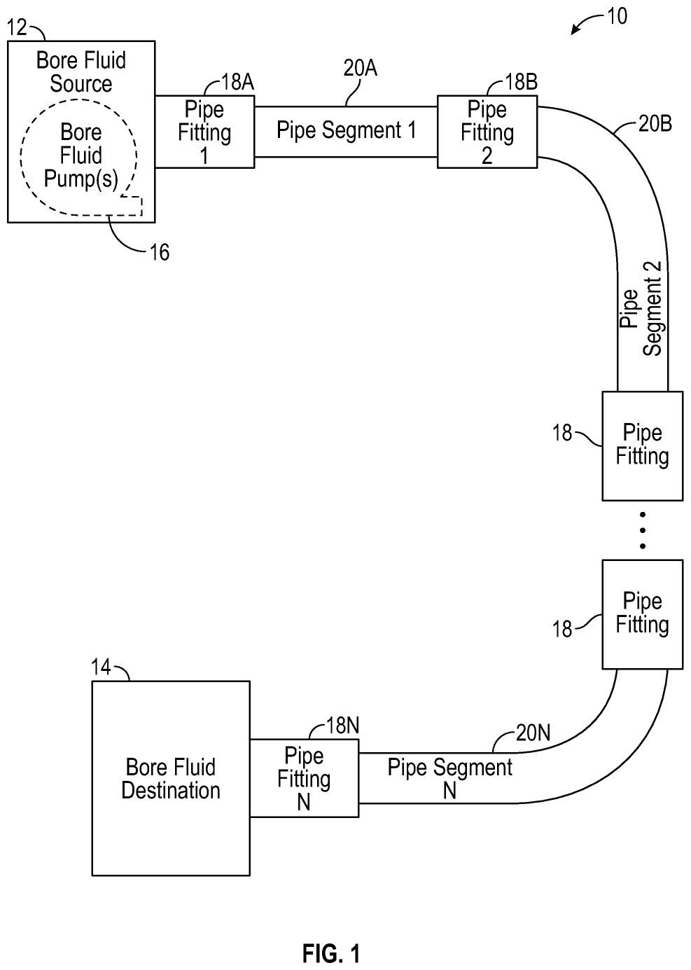

To help further illustrate, an example of a pipeline system 10 is shown in FIG. 1. As in the depicted example, the pipeline system 10 may be coupled between a bore fluid source 12 and a bore fluid destination 14. Merely as an illustrative non-limiting example, the bore fluid source 12 may be a production well and the bore fluid destination 14 may be a fluid storage tank. In other instances, the bore fluid source 12 may be a first (e.g., lease facility) storage tank and the bore fluid destination 14 may be a second (e.g., refinery) storage tank.

In any case, the pipeline system 10 may generally be implemented and/or operated to facilitate transporting (e.g., conveying) fluid, such as gas and/or liquid, from the bore fluid source 12 to the bore fluid destination 14. In fact, in some embodiments, the pipeline system 10 may be used in many applications, including without limitation, both onshore and offshore oil and gas applications. For example, in such embodiments, the pipeline system 10 may be used to transport one or more hydrocarbons, such as crude oil, petroleum, natural gas, or any combination thereof. Additionally or alternatively, the pipeline system 10 may be used to transport one or more other types of fluid, such as produced water, fresh water, fracturing fluid, flowback fluid, carbon dioxide, or any combination thereof.

To facilitate flowing fluid to the bore fluid destination 14, in some embodiments, the bore fluid source 12 may include one or more bore fluid pumps 16 that are implemented and/or operated to inject (e.g., pump and/or supply) fluid from the bore fluid source 12 into a bore of the pipeline system 10. However, it should be appreciated that the depicted example is merely intended to be illustrative and not limiting. In particular, in other embodiments, one or more bore fluid pumps 16 may not be implemented at the bore fluid source 12, for example, when fluid flow through the bore of the pipeline system 10 is produced by gravity. Additionally or alternatively, in other embodiments, one or more bore fluid pumps 16 may be implemented in the pipeline system 10 and/or at the bore fluid destination 14.

To facilitate transporting fluid from the bore fluid source 12 to the bore fluid destination 14, as in the depicted example, a pipeline system 10 may include one or more pipe fittings (e.g., connectors) 18 and one or more pipe segments 20. For example, the depicted pipeline system 10 includes a first pipe segment 20A, a second pipe segment 20B, and an Nth pipe segment 20N. Additionally, the depicted pipeline system 10 includes a first pipe (e.g., end) fitting 18A, which couples the bore fluid source 12 to the first pipe segment 20A, a second pipe (e.g., midline) fitting 18B, which couples the first pipe segment 20A to the second pipe segment 20B, and an Nth pipe (e.g., end) fitting 18N, which couples the Nth pipe segment 20N to the bore fluid destination 14.

However, it should again be appreciated that the depicted example is merely intended to be illustrative and not limiting. In particular, in other embodiments, a pipeline system 10 may include fewer (e.g., one) pipe segments 20. Additionally or alternatively, in other embodiments, a pipeline system 10 may include fewer (e.g., two) pipe fittings 18.

In any case, as described above, a pipe segment 20 generally includes tubing that may be used to convey (e.g., transfer and/or transport) water, gas, oil, and/or any other suitable type of fluid. The tubing of a pipe segment 20 may be made of any suitable type of material, such as plastic, metal, and/or a composite (e.g., fiber-reinforced composite) material. In fact, as will be described in more detail below, in some embodiments, the tubing of a pipe segment 20 may be implemented using multiple different layers. For example, the tubing of a pipe segment 20 may include a first high-density polyethylene (e.g., internal corrosion protection) layer, one or more reinforcement (e.g., steel strip) layers external to the first high-density polyethylene layer, and a second high-density polyethylene (e.g., external corrosion protection) layer external to the one or more reinforcement layers.

Additionally, as in the depicted example, one or more (e.g., second and/or Nth) pipe segments 20 in the pipeline system 10 may be curved. To facilitate implementing a curve in a pipe segment 20, in some embodiments, the pipe segment 20 may be flexible, for example, such that the pipe segment 20 is spoolable on a reel and/or in a coil (e.g., during transport and/or before deployment of the pipe segment 20). In other words, in some embodiments, one or more pipe segments 20 in the pipeline system 10 may be a flexible pipe, such as a bonded flexible pipe, an unbonded flexible pipe, a flexible composite pipe (FCP), a thermoplastic composite pipe (TCP), or a reinforced thermoplastic pipe (RTP). In fact, at least in some instances, increasing flexibility of a pipe segment 20 may facilitate improving deployment efficiency of a pipeline system 10, for example, by obviating a curved (e.g., elbow) pipe fitting 18 and/or enabling the pipe segment 20 to be transported to the pipeline system 10, deployed in the pipeline system 10, or both using a tighter spool.

To facilitate improving flexibility, in some embodiments, the tubing of a pipe segment 20 that defines (e.g., encloses) its pipe bore may include one or more openings devoid of solid material. In fact, in some embodiments, an opening in the tubing of a pipe segment 20 may run (e.g., span) the length of the pipe segment 20 and, thus, define (e.g., enclose) a fluid conduit in the annulus of the tubing, which is separate from the pipe bore. In other words, in such embodiments, fluid may flow through a pipe segment 20 via its pipe bore, a fluid conduit implemented within its tubing annulus, or both.

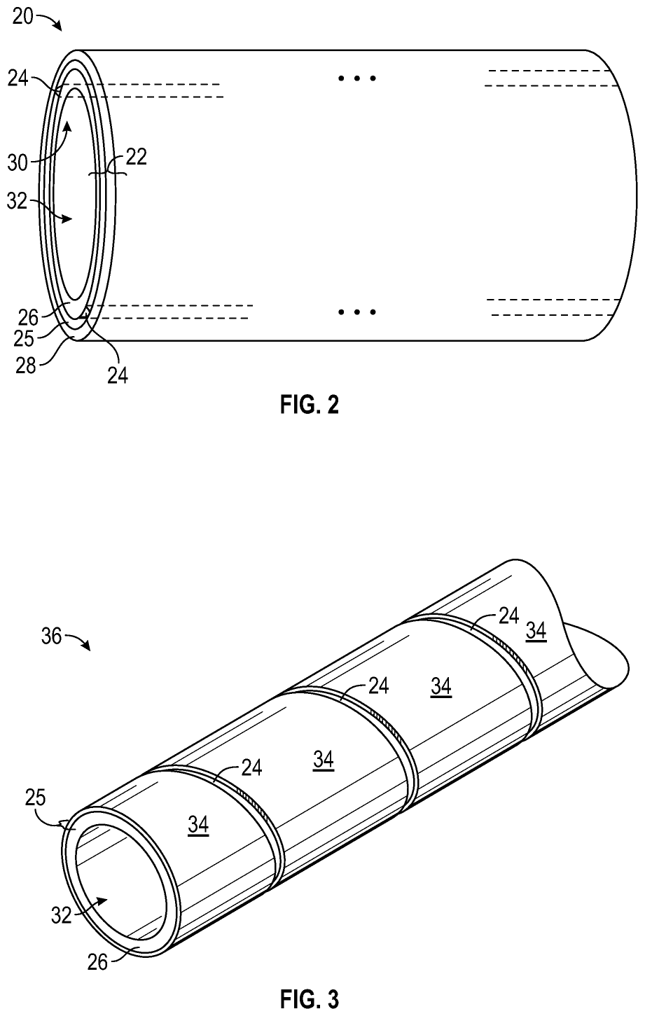

To help illustrate, an example of a pipe segment 20, which includes tubing 22 with fluid conduits 24 implemented in its annulus 25, is shown in FIG. 2. As depicted, the pipe segment tubing 22 is implemented with multiple layers including an inner (e.g., innermost) layer 26 and an outer (e.g., outermost) layer 28. In some embodiments, the inner layer 26 and/or the outer layer 28 of the pipe segment tubing 22 may be implemented using composite material and/or plastic, such as high-density polyethylene (HDPE) and/or raised temperature polyethylene (PE-RT). In any case, as depicted, an inner surface 30 of the inner layer 26 defines (e.g., encloses) a pipe bore 32 through which fluid can flow, for example, to facilitate transporting fluid from a bore fluid source 12 to a bore fluid destination 14.

Additionally, as depicted, the annulus 25 of the pipe segment tubing 22 is implemented between its inner layer 26 and its outer layer 28. As will be described in more detail below, the tubing annulus 25 may include one or more intermediate layer of the pipe segment tubing 22. Furthermore, as depicted, fluid conduits 24 running along the length of the pipe segment 20 are defined (e.g., enclosed) in the tubing annulus 25. As described above, a fluid conduit 24 in the tubing annulus 25 may be devoid of solid material. As such, pipe segment tubing 22 that includes one or more fluid conduits 24 therein may include less solid material and, thus, exert less resistance to flexure, for example, compared to a solid pipe segment tubing 22 and/or pipe segment tubing 22 that does not include fluid conduits 24 implemented therein. Moreover, to facilitate further improving flexibility, in some embodiments, one or more layers in the tubing 22 of a pipe segment 20 may be unbonded from one or more other layers in the tubing 22 and, thus, the pipe segment 20 may be an unbonded pipe.

However, it should be appreciated that the depicted example is merely intended to be illustrative and not limiting. In particular, in other embodiments, pipe segment tubing 22 may include fewer (e.g., one) or more (e.g., three, four, or more) fluid conduits 24 defined in its tubing annulus 25. Additionally or alternatively, in other embodiments, a fluid conduit 24 defined in the tubing annulus 25 of a pipe segment 20 may run non-parallel to the pipe bore 32 of the pipe segment 20, for example, such that the fluid conduit 24 is skewed relative to the axial (e.g., longitudinal) extent of the pipe bore 32.

To help illustrate, an example of a portion 36 of a pipe segment 20, which includes an inner layer 26 and an intermediate layer 34 included in the annulus 25 of its pipe segment tubing 22, is shown in FIG. 3. In some embodiments, one or more intermediate layers 34 of pipe segment tubing 22 may be implemented at least in part using composite material and/or metal, such as carbon steel, stainless steel, duplex stainless steel, super duplex stainless steel, or any combination thereof. In other words, at least in some such embodiments, the intermediate layer 34 of the pipe segment tubing 22 may be implemented using electrically conductive, which, at least in some instances, may enable communication of electrical (e.g., control and/or sensor) signals via the intermediate layer 34.

In any case, as depicted, the intermediate layer 34 is helically disposed (e.g., wound and/or wrapped) on the inner layer 26 such that gaps (e.g., openings) are left between adjacent windings to define a fluid conduit 24. In other words, in some embodiments, the intermediate layer 34 may be implemented at least in part by winding a metal (e.g., steel) strip around the inner layer 26 at a non-zero lay angle (e.g., fifty-four degrees) relative to the axial (e.g., longitudinal) extent of the pipe bore 32. In any case, as depicted, the resulting fluid conduit 24 runs helically along the pipe segment 20, for example, such that the fluid conduit 24 is skewed fifty-four degrees relative to the axial extent of the pipe bore 32.

In some embodiments, an outer layer 28 may be disposed directly over the depicted intermediate layer 34 and, thus, cover and/or define (e.g., enclose) the depicted fluid conduit 24. However, in other embodiments, the tubing annulus 25 pipe segment tubing 22 may include multiple (e.g., two, three, four, or more) intermediate layers 34. In other words, in such embodiments, one or more other intermediate layers 34 may be disposed over the depicted intermediate layer 34. In fact, in some such embodiments, the one or more other intermediate layers 34 may also each be helically disposed such that gaps are left between adjacent windings to implement one or more corresponding fluid conduits 24 in the pipe segment tubing 22.

For example, a first other intermediate layer 34 may be helically disposed on the depicted intermediate layer 34 using the same non-zero lay angle as the depicted intermediate layer 34 to cover (e.g., define and/or enclose) the depicted fluid conduit 24 and to implement another fluid conduit 24 in the first other intermediate layer 34. Additionally, a second other intermediate layer 34 may be helically disposed on the first other intermediate layer 34 using another non-zero lay angle, which is the inverse of the non-zero lay angle of the depicted intermediate layer 34, to implement another fluid conduit 24 in the second other intermediate layer 34. Furthermore, a third other intermediate layer 34 may be helically disposed on the second other intermediate layer 34 using the same non-zero lay angle as the second other intermediate layer 34 to cover the other fluid conduit 24 in the second other intermediate layer 34 and to implement another fluid conduit 24 in the third other intermediate layer 34. In some embodiments, an outer layer 28 may be disposed over the third other intermediate layer 34 and, thus, cover (e.g., define and/or enclose) the other fluid conduit 24 in the third other intermediate layer 34.

In any case, to facilitate flowing fluid from a bore fluid source 12 to a bore fluid destination 14, as described above, one or more pipe fittings 18, such as a midline pipe fitting 18 and/or a pipe end fitting 18, may be secured to a pipe segment 20. In particular, as described above, in some instances, a pipe fitting 18 may be secured to a pipe segment 20 using swaging techniques, for example, which conformally deform the pipe fitting 18 around tubing 22 of the pipe segment 20. In fact, in some embodiments, deployment equipment, such as a swage machine, may be implemented and/or operated to facilitate securing a pipe fitting 18 to a pipe segment 20 during field deployment of a pipeline system 10.

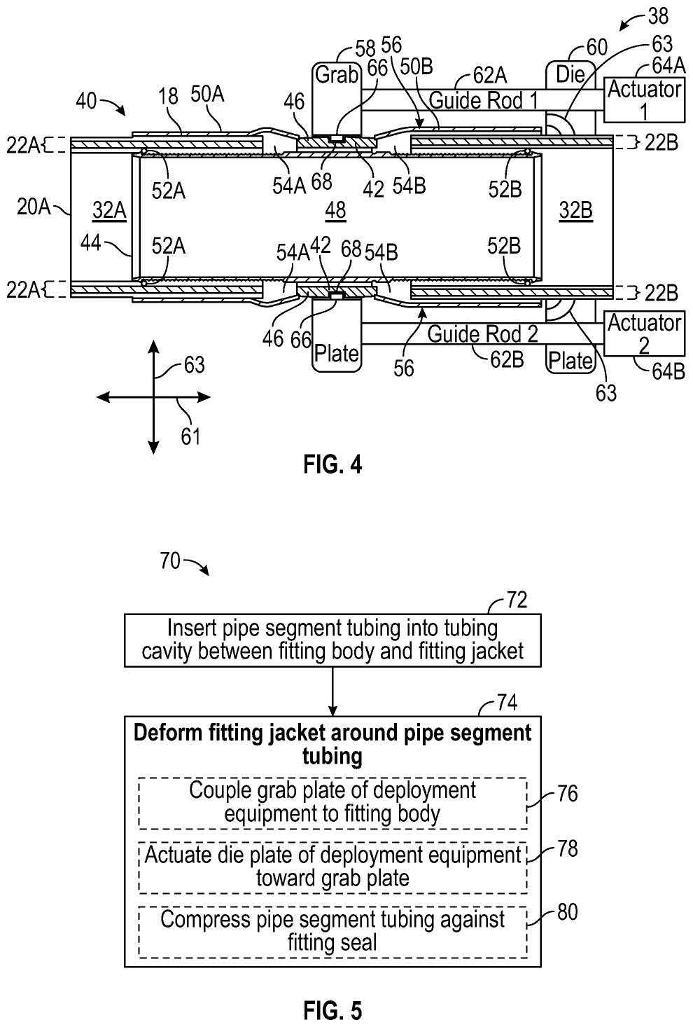

To help illustrate, an example cross-section of deployment equipment 38 and a portion 40 of a pipeline system 10 is shown in FIG. 4. As depicted, the portion 40 of the pipeline system 10 includes a first pipe segment 20A, a second pipe segment 20B, and a pipe fitting 18, which is coupled between the first pipe segment 20A and the second pipe segment 20B. Additionally, as depicted, a fitting body 42 of the pipe fitting 18 includes a fitting tube 44 and a grab ring 46, which is implemented around the fitting tube 44. In particular, as depicted, the fitting tube 44 defines (e.g., encloses) a fitting bore 48, which is fluidly coupled to a first pipe bore 32A of the first pipe segment 20A and a second pipe bore 32B of the second pipe segment 20B.

In other words, the pipe fitting 18 in FIG. 4 may be a midline pipe fitting 18. However, it should be appreciated that the depicted example is merely intended to be illustrative and not limiting. In particular, as will be described in more detail below, the techniques described in the present disclosure may additionally or alternatively be used with a pipe end fitting 18.

In any case, as depicted, the pipe fitting 18 includes fitting jackets 50—namely a first fitting jacket 50A and a second fitting jacket 50B—coupled to its fitting body 42 and fitting seals 52—namely a first fitting seal 52A and a second fitting seal 52B—implemented circumferentially around the fitting tube 44. In particular, as depicted, first tubing 22A of the first pipe segment 20A is disposed in a first tubing cavity 54A, which is defined between the first fitting jacket 50A and the fitting body 42. Similarly, second tubing 22A of the second pipe segment 20B is disposed in a second tubing cavity 54B, which is defined between the second fitting jacket 50B and the fitting body 42.

However, as depicted, open space 56 is present between the second tubing 22B of the second pipe segment 20B and the pipe fitting 18 whereas minimal open space is present between the first tubing 22A of the first pipe segment 20A and the pipe fitting 18. In other words, the pipe fitting 18 may exert more resistance to tubing movement in the first tubing cavity 54A and, thus, facilitate securing the pipe fitting 18 to the first pipe segment 20A, for example, in addition to sealing the first pipe segment 20A via the first fitting seal 52A. On the other hand, the pipe fitting 18 may exert less resistance to tubing movement in the second tubing cavity 54B, which, at least in some instances, may enable the second tubing 22B of the second pipe segment 20B to move relatively freely into and/or out from the second tubing cavity 54B of the pipe fitting 18. As such, to facilitate securing the pipe fitting 18 to the second pipe segment 20B, the deployment equipment 38 may be operated to conformally deform (e.g., swage) the second fitting jacket 50B around the second tubing 22B of the second pipe segment 20B, thereby consuming at least a portion (e.g., majority) of the open space 56.

To facilitate conformally deforming a fitting jacket 50 around pipe segment tubing 22, as in the depicted example, the deployment equipment 38 may include a grab plate 58, a die plate 60, one or more guide rods 62, and one or more actuators 64. More specifically, in the depicted example, the deployment equipment 38 includes a first actuator 64A, which is coupled to the grab plate 58 via a first guide rod 62A that extends through the die plate 60. Additionally, the deployment equipment 38 includes a second actuator 64B, which is coupled to the grab plate 58 via a second guide rod 62B that extends through the die plate 60. As such, in some embodiments, the first actuator 64A and/or the second actuator 64B may be operated to selectively push the die plate 60 toward the grab plate 58 and/or to selectively pull the die plate 60 away from the grab plate 58.

Furthermore, as depicted, a die (e.g., one or more die segments or die halves) 64 is disposed in the die plate 60. When compressed against a fitting jacket 50 in the axial direction 61, the shape of the die 63 may compress the fitting jacket 50 inwardly in a radial direction 63, for example, such that the fitting jacket 50 and pipe segment tubing 22 disposed in a corresponding tubing cavity 54 are conformally deformed. In fact, in some embodiments, different dies 64 may be selectively used in the die plate 60, for example, during successive compression cycles and/or depending on characteristics, such as diameter and/or material thickness, of the fitting jacket 50.

To facilitate compressing the die plate 60 and, thus, its die 63 against a fitting jacket 50, as in the depicted example, the grab plate 58 of the deployment equipment 38 may be secured to the pipe fitting 18 via one or more equipment grab tabs 66. In particular, as in the depicted example, an equipment grab tab 66 on the deployment equipment 38 may be implemented (e.g., sized and/or shaped) to matingly interlock (e.g., interface and/or engage) with a corresponding grab notch 68 on the grab ring 46 of the pipe fitting 18 and, thus, facilitate securing the deployment equipment 38 to the pipe fitting 18. As described above, the deployment equipment 38 may then force (e.g., push and/or compress) its die plate 60 and, thus, its die 63 toward its grab plate 58, which, at least in some instances, may conformally deform the second fitting jacket 50B of the pipe fitting 18 and the second tubing 22B of the second pipe segment 20B and, thus, facilitate securing the pipe fitting 18 to the pipe segment 20B, for example, in addition to sealing the second pipe segment 20B via the second fitting seal 52B. In this manner, deployment equipment 38 may be implemented and/or operated to facilitate deploying a pipe fitting 18 at a pipe segment 20.

To help further illustrate, an example of a process 70 for deploying a pipe fitting 18 at a pipe segment 20 is described in FIG. 5. Generally, the process 70 includes inserting pipe segment tubing into a tubing cavity between a fitting body and a fitting jacket (process block 72) and deforming the fitting jacket around the pipe segment tubing (process block 74). Although described in a specific order, which corresponds with an embodiment of the present disclosure, it should be appreciated that the example process 70 is merely intended to be illustrative and non-limiting. In particular, in other embodiments, a process 70 for deploying a pipe fitting 18 may include one or more additional process blocks and/or omit one or more of the depicted process blocks.

In any case, as described above, a pipe fitting 18 may include a tubing cavity 54, which is implemented to interface with the tubing 22 of a pipe segment 20 at which the pipe fitting 18 is to be deployed. In particular, as described above, the tubing cavity 54 may be defined (e.g., enclosed) between the fitting body 42 and a corresponding fitting jacket 50. For example, in some embodiments, the tubing cavity 54 may be defined between an inner surface of the fitting jacket 50 and an outer surface of a fitting tube 44 of the fitting body 42. Thus, in such embodiments, the pipe fitting 18 may be deployed at least in part by inserting the tubing 22 of the pipe segment 20 into a tubing cavity 54 of the pipe fitting 18 (process block 72).

Furthermore, as described above, in some embodiments, a pipe fitting 18 may be secured to a pipe segment 20 using swaging techniques. In particular, as described above, in such embodiments, swaging techniques may be used to conformally deform a fitting jacket 50 of the pipe fitting 18 around the tubing 22 of the pipe segment 20. In other words, in such embodiments, the pipe fitting 18 may be deployed at least in part by deforming the fitting jacket 50 around the tubing 22 of the pipe segment 20 (process block 74).

Moreover, as described above, in some embodiments, deployment equipment 38, such as a swage machine, may be used to facilitate deploying a pipe fitting 18 at a pipe segment 20 in the field. In particular, as described above, in some such embodiments, the deployment equipment 38 may include a grab tab 66 on its grab plate 58, which is implemented (e.g., shaped and/or sized) to mating interface with a corresponding grab notch 68 on a grab ring 46 of a fitting body 42. Additionally, as described above, in some such embodiments, the deployment equipment 38 may include a die plate 60 with a die 63, which, when compressed against a fitting jacket 50 in an axial direction 61, may compress the fitting jacket inwardly in a radial direction 63. In other words, in some embodiments, deforming the fitting jacket 50 around the pipe segment tubing 22 may include coupling the grab plate 58 of the deployment equipment 38 to the fitting body 42 of the pipe fitting 18 (process block 76) and actuating the die plate 60 of the deployment equipment 38 toward the grab plate 58 (process block 78).

Additionally, as described above, in some embodiments, a pipe fitting 18 may include one or more fitting seals 52 implemented on its fitting body 42. In particular, in some such embodiments, a fitting seal 52 of the pipe fitting 18 may be an O-ring seal 52 implemented using elastic material, such as rubber, that is disposed circumferentially along an outer surface of the fitting tube 44, which is internal to a corresponding fitting jacket 50. As such, in some embodiments, deforming the fitting jacket 50 around the pipe segment tubing 22 may compress the pipe segment tube 22 against one or more fitting seals 52, for example, to facilitate sealing bore conditions from external environmental conditions (process block 80).

However, as described above, once a pipe fitting 18 is deployed in the field by swaging (e.g., securing) the pipe fitting 18 to a pipe segment 20, in some instances, the conformal deformation due to swaging may result in the pipe fitting 18 effectively being permanently coupled to the pipe segment 20. Additionally, even when the pipe segment 20 secured to the pipe fitting 18 is removable from the pipe fitting 18, in some such instances, the deformation of a fitting jacket 50 due to swaging may limit the ability of the pipe fitting 18 to be re-deployed in the field, for example, due to deformation of the fitting jacket 50 resulting in its inner surface diameter being less than the default (e.g., natural, original, and/or uncompressed) outer surface diameter of another pipe segment 20 deployed in the field. Furthermore, since hot tooling, such as welding, is generally avoided in the field, a fitting jacket 50 coupled to the fitting body 42 of the pipe fitting 18 using hot tooling techniques may effectively be permanently coupled to the fitting body 42 once transported to the field in which a pipeline system 10 is or is to be deployed.

In other words, at least in some instances, a pipe fitting 18 that is implemented to be deployed (e.g., secured) using swaging techniques may effectively be a one-time-use pipe fitting 18 and, thus, deploying the pipe fitting in a pipeline system 10 may potentially limit deployment efficiency of the pipeline system 10, for example, due to a change in deployment (e.g., layout and/or configuration) of the pipeline system 10 resulting in an increased number of new (e.g., not previously swaged) pipe fittings 18 being deployed therein. To facilitate improving pipeline deployment efficiency, as will be described in more detail below, the present disclosure provides techniques for implementing a pipe fitting 18 that is at least partially re-deployable (e.g., reusable) in the field (e.g., onsite), for example, without hot tooling, such as welding, and/or re-processing the pipe fitting 18 offsite (e.g., a manufacturing facility or plant). In particular, since swaging primarily deforms fitting jackets 50, the present disclosure provides techniques for implementing fitting jackets 50 with threading that enables different fitting jackets 50 to be selectively coupled to a fitting body 42 of a pipe fitting 18, for example, at different times to enable the fitting body 42 to be reused during re-deployment of the pipe fitting 18 in a pipeline system 10.

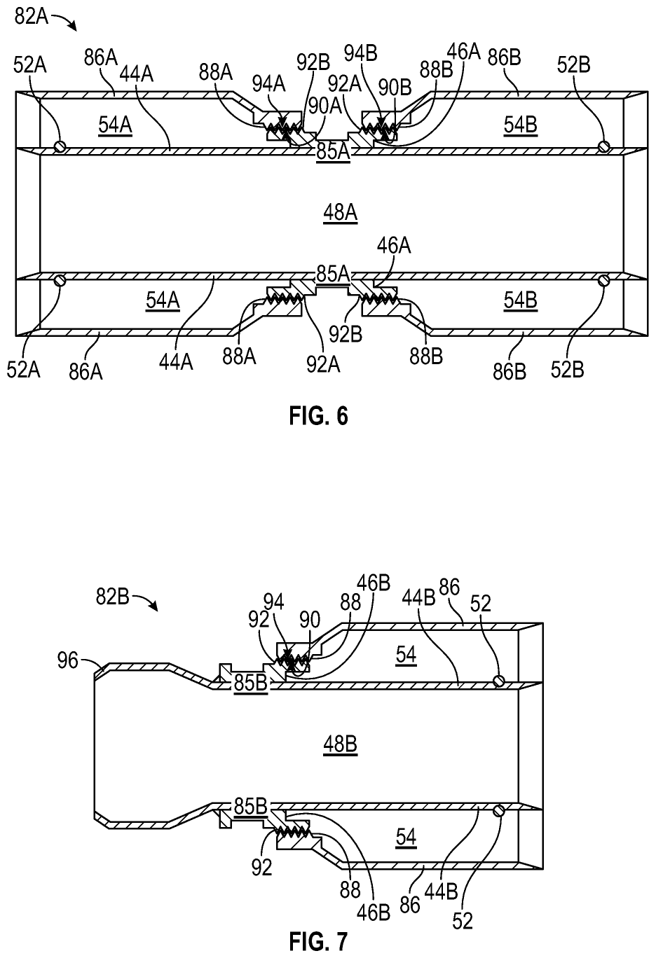

To help illustrate, an example cross-section of an at least partially re-deployable (e.g., reusable) pipe fitting 18—namely a re-deployable pipe fitting 82A—is shown in FIG. 6. As depicted, the re-deployable pipe fitting 82A includes a reusable fitting body 85A and threaded fitting jackets 86—namely a first threaded fitting jacket 86A and a second threaded fitting jacket 86B—that may each be selectively coupled (e.g., connected) to the reusable fitting body 85A and/or selectively removed (e.g., disconnected) from the reusable fitting body 85A. In particular, as depicted, first jacket threading 88A is implemented circumferentially along a first inner surface 90A of the first threaded fitting jacket 86A and second jacket threading 88B is implemented circumferentially along a second inner surface 90B of the second threaded fitting jacket 86B.

To facilitate selectively coupling a threaded fitting jacket 86 thereto and/or removing the threaded fitting jacket 86 therefrom, as depicted, the reusable fitting body 85A includes a fitting tube 44A, which defines a fitting bore 48A, and a threaded grab ring 46A, which is implemented around the fitting tube 44A. In particular, as depicted, the reusable fitting body 85A includes first body threading 92A, which is implemented along a first outer surface 94A of the threaded grab ring 46A to matingly interface (e.g., engage) with the first jacket threading 88A of the first threaded fitting jacket 86A. Additionally, as depicted, the reusable fitting body 85A includes second body threading 92B, which is implemented along a second outer surface 94B of the threaded grab ring 46A to matingly interface with the second jacket threading 88B of the second threaded fitting jacket 86B.

As will be described in more detail below, implementing the re-deployable pipe fitting 82A in this manner may enable one or more of its threaded fitting jackets 86 to be selectively swapped out, for example, in the field and/or without using hot tooling, such as welding. Merely as an illustrative non-limiting example, the first threaded fitting jacket 86A may be selectively coupled to the reusable fitting body 85A at least in part by actuating (e.g., rotating) the first threaded fitting jacket 86A in a first (e.g., clockwise) direction relative to the reusable fitting body 85A and/or selectively removed from the reusable fitting body 85A at least in part by actuating the first threaded fitting jacket 86A in a second (e.g., counter-clockwise and/or opposite) direction relative to the reusable fitting body 85A, for example, to enable a different (e.g., new and/or differently sized) threaded fitting jacket 86 to be coupled to the reusable fitting body 85A in place of the first threaded fitting jacket 86A. Similarly, the second threaded fitting jacket 86B may be selectively coupled to the reusable fitting body 85A at least in part by actuating the second threaded fitting jacket 86B in the first direction relative to the reusable fitting body 85A and/or selectively removed from the reusable fitting body 85A at least in part by actuating the second threaded fitting jacket 86B in the second direction relative to the reusable fitting body 85A, for example, to enable a different (e.g., new and/or differently sized) threaded fitting jacket 86 to be coupled to the reusable fitting body 85A in place of the second threaded fitting jacket 86B.

In any case, when the first threaded fitting jacket 86A is coupled to the reusable fitting body 85A, as depicted, a first tubing cavity 54A is defined therebetween. Thus, in some embodiments, the re-deployable pipe fitting 82A may be secured to a first pipe segment 20A using the process 70 of FIG. 5, for example, such that first tubing 22A of the first pipe segment 20A is secured in the first tubing cavity 54A via swaging (e.g., deformation) of the first threaded fitting jacket 86A and/or sealed in the first tubing cavity 54A at least in part via a first fitting seal 52A implemented around the fitting tube 44A. Similarly, when the second threaded fitting jacket 86B is coupled to the reusable fitting body 85A, as depicted, a second tubing cavity 54B is defined therebetween. Thus, in some embodiments, the re-deployable pipe fitting 82A may be secured to a second pipe segment 20B using the process 70 of FIG. 5, for example, such that second tubing 22B of the second pipe segment 20B is secured in the second tubing cavity 54B via swaging of the second threaded fitting jacket 86B and/or sealed in the second tubing cavity 54B at least in part via a second fitting seal 52B implemented around the fitting body 85A.

In other words, the re-deployable pipe fitting 82A of FIG. 6 may be a re-deployable midline pipe fitting 82A. However, it should be appreciated that the depicted example is merely intended to be illustrative and not limiting. In particular, as will be described in more detail below, in other embodiments, a reusable fitting body 85 and a threaded fitting jacket 86 may be implemented in a different manner, for example, such that the threaded fitting jacket 86 includes a threaded opening that aligns with a fastener opening, which extends through the reusable fitting body 85, to enable a threaded fastener that extends through the fastener opening to engage jacket threading in the threaded opening of the threaded fitting jacket 86. Additionally or alternatively, the techniques described in the present disclosure may be implemented with other types of pipe fittings 18, such as a pipe end fitting 18.

To help illustrate, another example cross-section of an at least partially re-deployable (e.g., reusable) pipe fitting 18—namely a re-deployable pipe fitting 82B—is shown in FIG. 7. As depicted, the re-deployable pipe fitting 82B includes a reusable fitting body 85B and a threaded fitting jacket 86, which may be selectively coupled (e.g., connected) to the reusable fitting body 85B and/or selectively removed (e.g., disconnected) from the reusable fitting body 85B. In particular, as depicted, jacket threading 88 is implemented circumferentially along an inner surface 90 of the threaded fitting jacket 86.

To facilitate selectively coupling a threaded fitting jacket 86 thereto and/or removing the threaded fitting jacket 86 therefrom, as depicted, the reusable fitting body 85B includes a fitting tube 44B, which defines a fitting bore 48B, and a threaded grab ring 46B, which is implemented around the fitting tube 44B. In particular, as depicted, the reusable fitting body 85B includes body threading 92, which is implemented circumferentially along an outer surface 94 of the threaded grab ring 46B. Additionally, as depicted, the body threading 92 and the jacket threading 88 on the threaded fitting jacket 86 are implemented to matingly interface (e.g., engage) with one another.

As will be described in more detail below, implementing the re-deployable pipe fitting 82B in this manner may enable its threaded fitting jacket 86 to be selectively swapped out, for example, in the field and/or without using hot tooling, such as welding. Merely as an illustrative non-limiting example, the threaded fitting jacket 86 may be selectively coupled to the reusable fitting body 85B at least in part by actuating (e.g., rotating) the threaded fitting jacket 86B in a first (e.g., clockwise) direction relative to the reusable fitting body 85B. On the other hand, the threaded fitting jacket 86 may be selectively removed from the reusable fitting body 85B at least in part by actuating the threaded fitting jacket 86B in a second (e.g., counter-clockwise and/or opposite) direction relative to the reusable fitting body 85B, for example, to enable a different (e.g., new and/or differently sized) threaded fitting jacket 86 to be coupled to the reusable fitting body 85A in its place.

In any case, when a threaded fitting jacket 86 is coupled to the reusable fitting body 85B, as depicted, a tubing cavity 54 that opens toward one side of the re-deployable pipe fitting 82B is defined therebetween. Thus, in some embodiments, the re-deployable pipe fitting 82B may be secured to a pipe segment 20 using the process 70 of FIG. 5, for example, such that tubing 22B of the pipe segment 20B is secured in the tubing cavity 54 via swaging (e.g., deformation) of the threaded fitting jacket 86 and/or sealed in the tubing cavity 54 at least in part via a fitting seal 52 implemented around the fitting tube 44B. Moreover, as depicted, an opposite end of the fitting tube 44B includes a weld neck 96, which may be used to couple the re-deployable pipe fitting 82B to a bore fluid source 12 and/or a bore fluid destination 14, for example, at least in part by securing (e.g., welding) the weld neck 96 directly thereto and/or via a flange secured (e.g., welded) to the weld neck 96.

In other words, the re-deployable pipe fitting 82B of FIG. 7 may be a re-deployable pipe end fitting 82B. However, it should be appreciated that the depicted example is merely intended to be illustrative and not limiting. In particular, as will be described in more detail below, in other embodiments, a reusable fitting body 85 and a threaded fitting jacket 86 may be implemented in a different manner. For example, in some other embodiments, the reusable fitting body 85 and the threaded fitting jacket 86 may be implemented such that the threaded fitting jacket 86 includes a threaded opening that aligns with a fastener opening, which extends through the reusable fitting body 85, to enable a threaded fastener that extends through the fastener opening to engage jacket threading in the threaded opening of the threaded fitting jacket 86. Additionally, in some other embodiments, the reusable fitting body 85 and the threaded fitting jacket 86 may be implemented such that jacket threading 88 is implemented on an outer surface of the threaded fitting jacket and body threading 92 is implemented on a corresponding inner surface of the reusable fitting body 85.

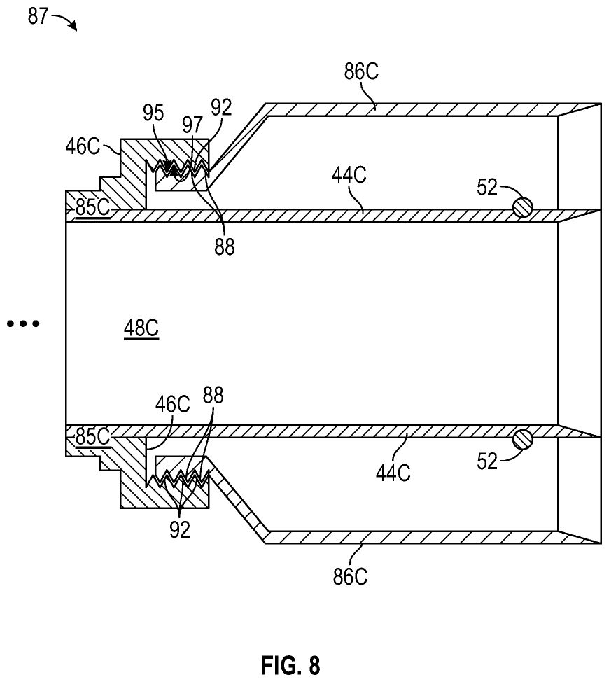

To help illustrate, another example cross-section of a portion 87 of a re-deployable pipe fitting 82 is shown in FIG. 8. In some embodiments, the depicted portion 87 may be included in a re-deployable pipe end fitting 82. In other embodiments, the depicted portion 87 may be included in a re-deployable midline pipe fitting 82, for example, such that two instances of the depicted portion 87 are implemented back-to-back.

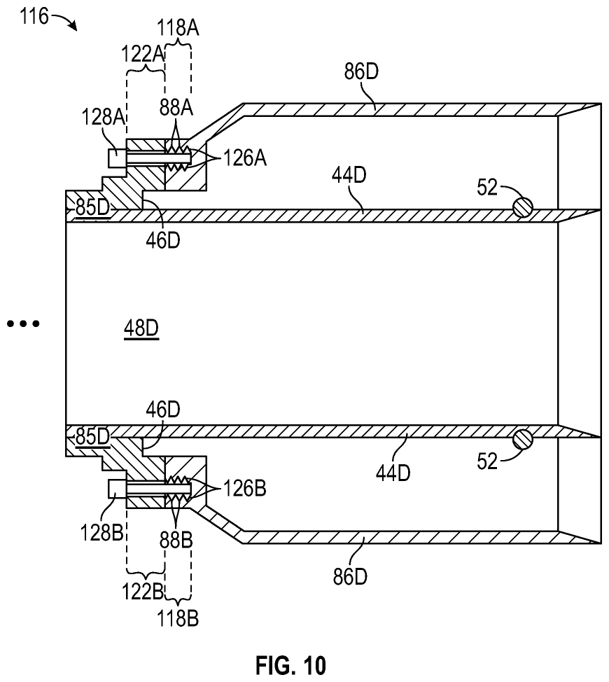

In any case, as depicted, the portion 87 of the re-deployable pipe fitting 82 includes a reusable fitting body 85C and a threaded fitting jacket 86C. Similar to the reusable fitting bodies 85 of FIGS. 6-8, the reusable fitting body 85C of FIG. 8 includes a fitting tube 44C, which defines (e.g., encloses) a fitting bore 48C, and a threaded grab ring 46C, which is implemented around the fitting tube 44C. In fact, in some embodiments, the fitting tube 44C of FIG. 8 may generally match the fitting tube 44A of FIG. 6 while, in other embodiments, the fitting tube 44D of FIG. 10 may generally match the fitting tube 44B of FIG. 7.

However, as depicted in FIG. 8, jacket threading 88 is implemented circumferentially along an outer surface 95 of the threaded fitting jacket 86C, for example, instead of an inner surface 90 of the threaded fitting jacket 86C. Additionally, as depicted, body threading 92 is implemented circumferentially along an inner surface 97 of the threaded grab ring 46C, for example, instead of an outer surface 94 of the threaded grab ring 46C. Nevertheless, as depicted, the jacket threading 88 on the threaded fitting jacket 86C and the body threading 92 on the threaded grab ring 46C are implemented to mating interface with one another.

Thus, similar to the threaded fitting jackets 86 of FIGS. 6-8, implementing a re-deployable pipe fitting 82 in this manner may enable its threaded fitting jacket 86 to be selectively swapped out. Merely as an illustrative non-limiting example, the threaded fitting jacket 86C may be selectively coupled to the reusable fitting body 85C at least in part by actuating (e.g., rotating) the threaded fitting jacket 86C in a first (e.g., clockwise) direction relative to the reusable fitting body 85C and/or selectively removed from the reusable fitting body 85C at least in part by actuating the threaded fitting jacket 86C in a second (e.g., counter-clockwise and/or opposite) direction relative to the reusable fitting body 85C, for example, to enable a different (e.g., new and/or differently sized) threaded fitting jacket 86 to be coupled to the reusable fitting body 85C in its place. In any case, implementing a (e.g., re-deployable and/or reusable) pipe fitting 18 with one or more threaded fitting jackets 86 may enable the pipe fitting 18 to be at least partially re-deployable (e.g., reusable) while in the field (e.g., onsite), for example, without hot tooling, such as welding, and/or re-processing the pipe fitting 18 offsite, which, at least in some instances, may facilitate improving pipeline deployment efficiency.

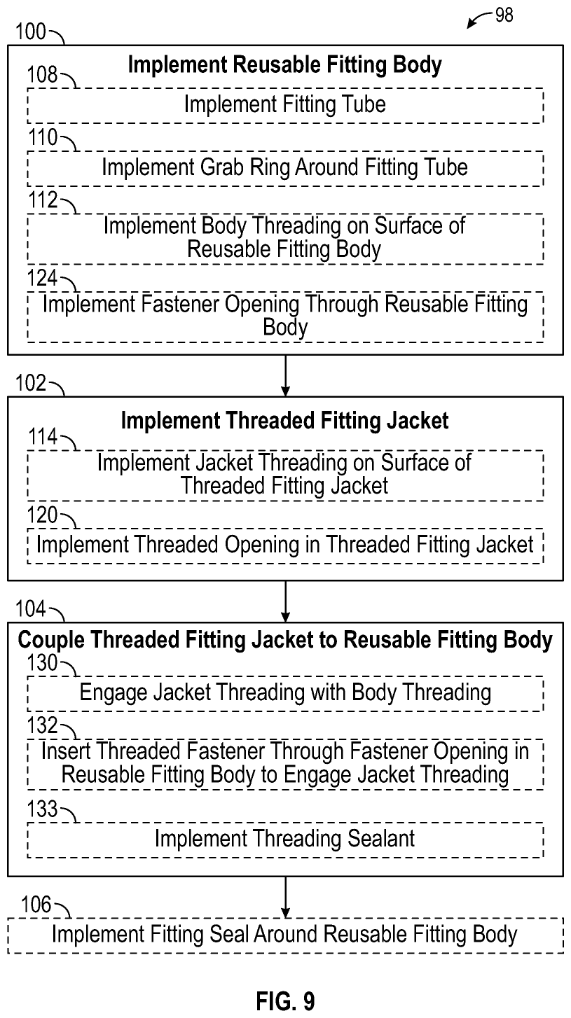

To help further illustrate, an example of a process 98 for implementing a re-deployable pipe fitting 82 is described in FIG. 9. Generally, the process 98 includes implementing a reusable fitting body (process block 100) and implementing a threaded fitting jacket (process block 102). Additionally, the process 98 generally includes coupling the threaded fitting jacket to the reusable fitting body (process block 104).

Although described in a specific order, which corresponds with an embodiment of the present disclosure, it should be appreciated that the example process 98 is merely intended to be illustrative and non-limiting. In particular, in other embodiments, a process 98 for implementing a re-deployable pipe fitting 82 may include one or more additional process blocks and/or omit one or more of the depicted process blocks. For example, some embodiments of the process 98 may additionally include implementing a fitting seal around the reusable fitting body (process block 106) while other embodiments of the process 98 do not. Additionally, some embodiments of the process 98 may include implementing a fitting seal around the reusable fitting body before a corresponding threaded fitting jacket is coupled to the reusable fitting body while other embodiments of the process 98 include implementing the fitting seal around the reusable fitting body after the corresponding threaded fitting jacket is coupled to the reusable fitting body.

In any case, as described above, a re-deployable pipe fitting 82 generally includes a reusable fitting body 85 and one or more threaded fitting jackets 86, which each includes jacket threading 88. As such, the re-deployable pipe fitting 82 may be implemented at least in part by implementing one or more threaded fitting jackets 86 (process block 102). Additionally, the re-deployable pipe fitting 82 may be implemented at least in part by implementing a reusable fitting body 85 (process block 100).

As described above, in some embodiments, the reusable fitting body 85 may including a fitting tube 44, which defines (e.g., encloses) a fitting bore 48, and a grab ring 46 implemented around the fitting tube 44. Thus, in such embodiments, implementing the reusable fitting body 85 may include implementing a fitting tube 44 to define a fitting bore 48 (process block 108). Additionally, in such embodiments, implementing the reusable fitting body 85 may include implementing a grab ring 46 around the fitting tube 44 (process block 110).

To facilitate providing reusability, as described with regard to FIGS. 6-8, in some embodiments, the reusable fitting body 85 may include body threading 92, for example, implemented on one or more surfaces of its grab ring 46. In other words, in such embodiments, implementing the reusable fitting body 85 may include implementing body threading 92 along one or more of its surfaces, such as an outer surface 94 of its threaded grab ring 46 and/or an inner surface 97 of its threaded grab ring 46 (process block 112). In particular, as described above, in such embodiments, the body threading 92 may be implemented to matingly interface (e.g., engage) with jacket threading 88 implemented on a threaded fitting jacket 86. In other words, in such embodiments, implementing the threaded fitting jacket 86 may include implementing jacket threading 88 along one or more of its surfaces, such as an inner surface 90 of the threaded fitting jacket 86 and/or an outer surface 95 of the threaded fitting jacket (process block 114). In some embodiments, the jacket threading 88 and/or the body threading 92 may include National Pipe Straight (NPS) threading, National Pipe Thread (NPT) threading, trapezoidal (e.g., Acme) threading, International Organization for Standardization (ISO) metric threading, Unified National Coarse (UNC) threading, Unified National Fine (UNF) threading, British Standard Parallel Pipe (BSPP) threading, British Standard Pipe Thread (BSPT) threading, or any combination thereof.

In any case, as described above, implementing the re-deployable pipe fitting 82 in this manner may enable different threaded fitting jackets 86 to be selectively coupled to its reusable fitting body 85 in the field (e.g., onsite), for example, without hot tooling, such as welding, and/or re-processing the pipe fitting 18 offsite (e.g., a manufacturing facility or plant). However, as briefly mentioned above, in other embodiments, a reusable fitting body 85 and threaded fitting jackets 86 may be implemented in a different manner to enable different threaded fitting jackets 86 to be selectively coupled to and/or remove from the reusable fitting body 85 in the field. For example, in some other embodiments, a threaded fitting jacket 86 may include a threaded opening that aligns with a fastener opening, which extends through a corresponding reusable fitting body 85, to enable a threaded end of a threaded fastener that extends through the fastener opening in the reusable fitting body 85 to engage jacket threading 88 in the threaded opening of the threaded fitting jacket 86.

To help illustrate, another example cross-section of a portion 116 of a re-deployable pipe fitting 82 is shown in FIG. 10. In some embodiments, the depicted portion 116 may be included in a re-deployable pipe end fitting 82. In other embodiments, the depicted portion 116 may be included in a re-deployable midline pipe fitting 82, for example, such that two instances of the depicted portion 116 are implemented back-to-back.

In any case, as depicted, the portion 116 of the re-deployable pipe fitting 82 includes a reusable fitting body 85D and a threaded fitting jacket 86D. Similar to the reusable fitting bodies 85 of FIGS. 6-8, the reusable fitting body 85D of FIG. 10 includes a fitting tube 44D, which defines (e.g., encloses) a fitting bore 48D, and a grab ring 46D, which is implemented around the fitting tube 44D. In fact, in some embodiments, the fitting tube 44D of FIG. 10 may generally match the fitting tube 44A of FIG. 6 while, in other embodiments, the fitting tube 44D of FIG. 10 may generally match the fitting tube 44B of FIG. 7. Additionally, similar to the threaded fitting jackets 86 of FIGS. 6-8, the threaded fitting jacket 86D of FIG. 10 may be selectively coupled (e.g., connected) to the reusable fitting body 85D and/or selectively removed (e.g., disconnected) from the reusable fitting body 85D.

However, as depicted in FIG. 10, the threaded fitting jacket 86D includes jacket threading 88 implemented in one or more threaded openings 118, for example, instead of an inner surface 90 or an outer surface 95 of the threaded jacket 86D. In particular, as depicted, first jacket threading 88A is implemented in a first threaded opening 118A of the threaded fitting jacket 86D and second jacket threading 88B is implemented in a second threaded opening 118B of the threaded fitting jacket 86D. In other words, returning to the process 98 of FIG. 9, in such embodiments, implementing the threaded fitting jacket 86 may include implementing one or more threaded openings 118 in the threaded fitting jacket 86 (process block 120).

Moreover, as depicted in FIG. 10, the reusable fitting body 85D includes fastener openings 122 that extend therethrough to align with corresponding threaded openings 118 in the threaded fitting jacket 86D. In particular, as depicted, the reusable fitting body 85D includes a first fastener opening 122A, which aligns with the first threaded opening 118A in the threaded fitting jacket 86D, and a second fastener opening 122B, which aligns with the second threaded opening 118B in the threaded fitting jacket 86D. In other words, returning to the process 98 of FIG. 9, in such embodiments, implementing the reusable fitting body 85 may include implementing one or more fastener openings 122 through the reusable fitting body 85 (process block 124).

By implementing the re-deployable pipe fitting 82 in this manner, as depicted in FIG. 10, fastener threading 126 of a threaded fastener 128, such as a bolt or a screw, that extends through a fastener opening 122 in the reusable fitting body 85 may engage jacket threading 88 in a corresponding threaded opening 118 of the threaded fitting jacket 86D. In particular, as depicted, first fastener threading 126A of a first threaded fastener 128A, which extends through the first fastener opening 122A, matingly interfaces (e.g., engages) with the first jacket threading 88A in the first threaded opening 118A of the threaded fitting jacket 86D. Additionally, as depicted, second fastener threading 126B of a second threaded fastener 128B, which extends through the second fastener opening 122B, matingly interfaces with the second jacket threading 88B in the second threaded opening 118B of the threaded fitting jacket 86D.

However, it should be appreciated that the depicted example is merely intended to be illustrative and not limiting. In particular, in other embodiments, a re-deployable pipe fitting 82 may include a single threaded fastener 128, a single fastener opening 122, and a single threaded opening 118. Additionally or alternatively, in other embodiments, one or more fastener openings 122 of a reusable fitting body 85 may each include body threading 92 implemented on an inward-facing surface of a corresponding fastener opening 122 and, thus, a grab ring 46 of the reusable fitting body 85 may be a threaded grab ring 46.

In any case, as will be described in more detail below, implementing the portion 116 of the re-deployable pipe fitting 82 in this manner may enable its threaded fitting jacket 86D to be selectively swapped out, for example, in the field and/or without using hot tooling, such as welding. Merely as an illustrative non-limiting example, the threaded fitting jacket 86D may be selectively coupled to the reusable fitting body 85D at least in part by actuating (e.g., rotating) the first threaded fastener 128A and/or the second threaded fastener 128B in a first (e.g., clockwise) direction relative to the threaded fitting jacket 86D. On the other hand, the threaded fitting jacket 86D may be selectively removed from the reusable fitting body 85D at least in part by actuating the first threaded fastener 128A and/or the second threaded fastener 128B in a second (e.g., counter-clockwise and/or opposite) direction relative to the threaded fitting jacket 86D, for example, to enable a different (e.g., new and/or differently sized) threaded fitting jacket 86 to be coupled to the reusable fitting body 85D in its place.

Returning to the process 98 of FIG. 9, one or more threaded fitting jackets 86 may then be coupled (e.g., secured) to the reusable fitting body 85 of the re-deployable pipe fitting 82 to define a corresponding tubing cavity 54 (process block 104). As described above with regard to FIGS. 6-8, in some embodiments, a threaded fitting jacket 86 may include jacket threading 88, which is implementing along an inner surface 90 or an outer surface 95 of the threaded fitting jacket 86 to matingly engage (e.g., interface) with body threading 92 implemented along an outer surface 94 or an inner surface 97 of the reusable fitting body 85. In other words, in such embodiments, coupling the threaded fitting jacket 86 to the reusable fitting body 85 may include engaging the jacket threading 88 on the threaded fitting jacket 86 with body threading 92 on the reusable fitting body 85, for example, at least in part by actuating (e.g., rotating) the threaded fitting jacket in a first (e.g., clockwise) direction relative to the reusable fitting body 85 (process block 130).

Additionally, as described above with regard to FIG. 10, in other embodiments, a threaded fitting jacket 86 may include jacket threading 88, which is implemented in a threaded opening 118 of the threaded fitting jacket 86 that is to be aligned with a corresponding fastener opening 122 in the reusable fitting body 85. In particular, as described above, in such embodiments, the threaded opening 118 in the threaded fitting jacket 86 may be aligned with a corresponding fastener opening 122 in the reusable fitting body 85 to enable fastener threading 126 of a threaded fastener 128, which extends through the fastener opening 122, to matingly engage (e.g., interface) with the jacket threading 88 in the threaded opening 118 of the threaded jacket 86. In other words, in such embodiments, coupling the threaded fitting jacket 86 to the reusable fitting body 85 may include inserting a threaded fastener 128 through the fastener opening 122 in the reusable fitting body 85 to engage the jacket threading 88 in the threaded opening 118 of the threaded jacket 86, for example, at least in part by actuating (e.g., rotating) the threaded fastener 128 in a first (e.g., clockwise) direction relative to the threaded fitting jacket 86 (process block 132).

In any case, to facilitate reducing the likelihood of inadvertent fluid flow into and/or out from the corresponding tubing cavity 54, in some embodiments, coupling the threaded fitting jacket 86 to the reusable fitting body 85 may include implementing threading sealant at the junction between the jacket threading 88 and the body threading 92 (process block 133). For example, in some such embodiments, the threading sealant may be implemented at least in part by coating (e.g., spraying) the jacket threading 88 and/or the body threading 92 with a sealing material before being coupled together. Additionally or alternatively, the threading sealant may be implemented at least in part by wrapping a sealing material (e.g., tape) around the junction between the jacket threading 88 and the body threading 92.

Furthermore, as described above, in some embodiments, implementing the re-deployable pipe fitting 82 may additionally include implementing one or more fitting seals 52 around its reusable fitting body 85 (process block 106). For example, in some such embodiments, a fitting seal 52 may be implemented at least in part by forming a seal cavity (e.g., groove) circumferentially around an outer surface of the fitting tube 44 and disposing an elastic material, such as rubber, in the seal cavity. Additionally, in some such embodiments, a fitting seal 52 may be disposed in the seal cavity once the re-deployable pipe fitting 82 is in the field (e.g., onsite), for example, by an operator or a service technician. In other such embodiments, a fitting seal 52 may be disposed in the seal cavity during an initial manufacturing process, for example, performed offsite in a manufacturing plant or factory. In any case, implementing the re-deployable pipe fitting 82 is this manner may enable the re-deployable pipe fitting 82 to be at least partially reused (e.g., re-deployed) in a pipeline system 10, which, at least in some instances, may facilitate improving deployment efficiency of the pipeline system 10, for example, by enabling a reduction in the number of new (e.g., not previously deployed) pipe fitting 18 deployed therein.

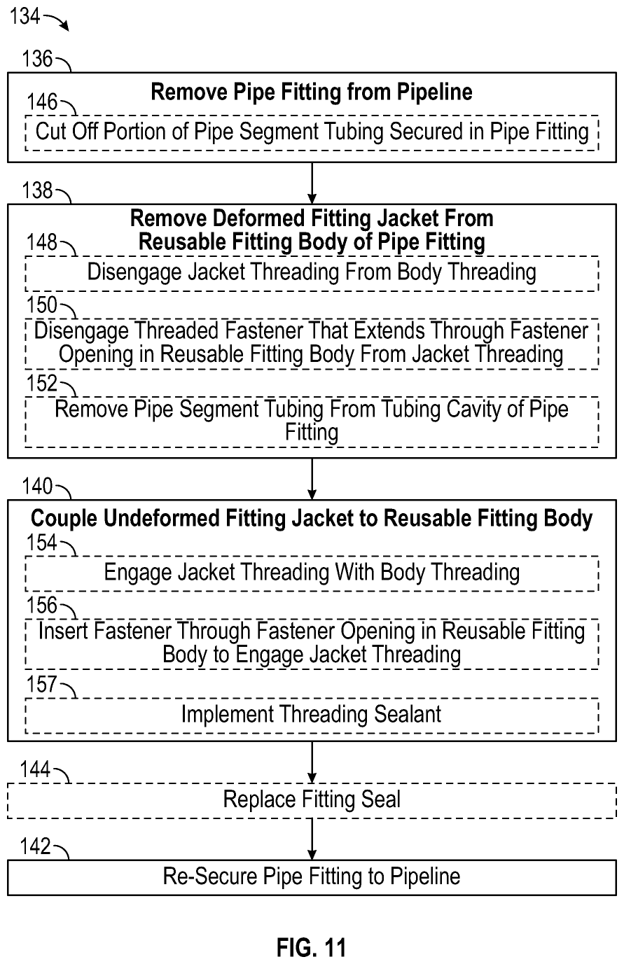

To help further illustrate, an example of a process 134 for re-deploying a (e.g., re-deployable) pipe fitting 18 is described in FIG. 11. Generally, the process 134 includes removing a pipe fitting from a pipeline (process block 136) and removing a deformed fitting jacket from a reusable fitting body of the pipe fitting (process block 138). Additionally, the process 134 generally includes coupling an undeformed fitting jacket to the reusable fitting body (process block 140) and re-securing the pipe fitting to a pipeline (process block 142).

Although described in a specific order, which corresponds with an embodiment of the present disclosure, it should be appreciated that the example process 134 is merely intended to be illustrative and non-limiting. In particular, in other embodiments, a process 134 for re-deploying a pipe fitting 18 may include one or more additional process blocks and/or omit one or more of the depicted process blocks. For example, some embodiments of the process 134 may additionally include replacing a fitting seal (process block 144) while other embodiments of the process 134 do not. Additionally, some embodiments of the process 134 may include replacing a fitting seal before a corresponding undeformed fitting jacket is coupled to the reusable fitting body while other embodiments of the process 134 include replacing the fitting seal after the corresponding deformed fitting jacket is coupled to the reusable fitting body.

In any case, as described above, a pipe fitting 18, such as a re-deployable pipe fitting 82, may be deployed in a pipeline system 10 at least in part by securing the pipe fitting 18 to a pipe segment 20 in the pipeline system 10, for example, using swaging techniques. Thus, to enable re-deployment, the re-deployable pipe fitting 82 may be removed from the pipeline system 10 (process block 136). In particular, to facilitate removing the re-deployable pipe fitting 18 from the pipeline system 10, in some embodiments, the re-deployable pipe fitting 18 as well as a portion of pipe segment tubing 22 secured therein may be cut off from the rest of the pipeline system 10 (process block 146).

A threaded fitting jacket 86 that was previously deformed due to swaging may then be removed from the reusable fitting body 85 of the re-deployable pipe fitting 82 (process block 138). As described above with regard to FIGS. 6-8, in some embodiments, a threaded fitting jacket 86 may include jacket threading 88, which is implementing along an inner surface 90 or an outer surface 95 of the threaded fitting jacket 86 to matingly engage (e.g., interface) with body threading 92 implemented along an outer surface 94 or an inner surface 97 of the reusable fitting body 85. Thus, in such embodiments, removing the threaded fitting jacket 86, which was previously deformed, may include disengaging the jacket threading 88 on the threaded fitting jacket 86 from body threading 92 on the reusable fitting body 85, for example, at least in part by actuating (e.g., rotating) the threaded fitting jacket 86 in a second (e.g., counter-clockwise) direction relative to the reusable fitting body 85 (process block 148).

Additionally, as described above with regard to FIG. 10, in other embodiments, a threaded fitting jacket 86 may include jacket threading 88, which is implemented in a threaded opening 118 of the threaded fitting jacket 86 that is to be aligned with a corresponding fastener opening 122 in the reusable fitting body 85. In particular, as described above, in such embodiments, the threaded opening 118 in the threaded fitting jacket 86 may be aligned with a corresponding fastener opening 122 in the reusable fitting body 85 to enable fastener threading 126 of a threaded fastener 128, which extends through the fastener opening 122, to matingly engage (e.g., interface) with the jacket threading 88 in the threaded opening 118 of the threaded jacket 86. Thus, in such embodiments, removing the threaded fitting jacket 86, which was previously deformed, may include disengaging a threaded fastener 128, which extends through the fastener opening 122 in the reusable fitting body 85, from the jacket threading 88 in the threaded opening 118 of the threaded jacket 86, for example, at least in part by actuating (e.g., rotating) the threaded fastener 128 in a second (e.g., counter-clockwise) direction relative to the threaded fitting jacket 86 (process block 150).

In any case, as described above, a tubing cavity 54 of a pipe fitting 18 in which pipe segment tubing 22 is to be secured may be defined (e.g., enclosed) between its fitting body 42 and a corresponding fitting jacket 50. As such, access to a corresponding tubing cavity 54 may be increased once the threaded fitting jacket 86 has been removed from the reusable fitting body 85 of the re-deployable pipe fitting 82. In fact, in embodiments where a portion of pipe segment tubing 22 secured therein is cut off from the pipeline system 10, removing the threaded fitting jacket 86, which was previously deformed, may facilitate removing the portion of the pipe segment tubing 22 from a corresponding tubing cavity 54 of the re-deployable pipe fitting 82 (process block 152).

A threaded fitting jacket 86, which has not been previously deformed due to swaging, may then be coupled to the reusable fitting body 85 (process block 140). As described above with regard to FIGS. 6-8, in some embodiments, a threaded fitting jacket 86 may include jacket threading 88, which is implemented along an inner surface 90 or an outer surface 95 of the threaded fitting jacket 86 to matingly engage (e.g., interface) with body threading 92 implemented along an outer surface 94 or an inner surface 97 of the reusable fitting body 85. Thus, in such embodiments, coupling the threaded fitting jacket 86, which has not been previously deformed due to swaging, may include engaging the jacket threading 88 on the threaded fitting jacket 86 with the body threading 92 on the reusable fitting body 85, for example, at least in part by actuating (e.g., rotating) the threaded fitting jacket 86 in a first (e.g., clockwise) direction relative to the reusable fitting body 85 (process block 154).

Additionally, as described above with regard to FIG. 10, in other embodiments, a threaded fitting jacket 86 may include jacket threading 88, which is implemented in a threaded opening 118 of the threaded fitting jacket 86 that is to be aligned with a corresponding fastener opening 122 in the reusable fitting body 85. In particular, as described above, in such embodiments, the threaded opening 118 in the threaded fitting jacket 86 may be aligned with a corresponding fastener opening 122 in the reusable fitting body 85 to enable fastener threading 126 of a threaded fastener 128, which extends through the fastener opening 122, to matingly engage (e.g., interface) with the jacket threading 88 in the threaded opening 118 of the threaded jacket 86. Thus, in such embodiments, coupling the threaded fitting jacket 86, which has not been previously deformed due to swaging, may include inserting a threaded fastener 128 through the fastener opening 122 in the reusable fitting body 85 to engage the jacket threading 88 in the threaded opening 118 of the threaded jacket 86, for example, at least in part by actuating (e.g., rotating) the threaded fastener 128 in a first (e.g., clockwise) direction relative to the threaded fitting jacket 86 (process block 156).

In any case, to facilitate reducing the likelihood of inadvertent fluid flow into and/or out from the corresponding tubing cavity 54, in some embodiments, coupling the undeformed threaded fitting jacket 86 to the reusable fitting body 85 may include implementing threading sealant at the junction between the jacket threading 88 and the body threading 92 (process block 157). For example, in some such embodiments, the threading sealant may be implemented at least in part by coating (e.g., spraying) the jacket threading 88 and/or the body threading 92 with a sealing material before being coupled together. Additionally or alternatively, the threading sealant may be implemented at least in part by wrapping a sealing material (e.g., tape) around the junction between the jacket threading 88 and the body threading 92.

After the threaded fitting jacket 86 that has not been previously deformed due to swaging is coupled to the reusable fitting body 85, the re-deployable pipe fitting 82 may be re-secured to a pipe segment 20 in the same pipeline system 10 or even a different pipeline system 10, for example, using the deployment process 70 of FIG. 5. As described above, swaging techniques used to secure a pipe fitting 18 to a pipe segment 20 may primarily compress a fitting jacket 50 of the pipe fitting 18 to deform the fitting jacket 50 around tubing 22 of the pipe segment 20. However, in some instances, the compression of the fitting jacket 50 may also result in some amount of deformation on the fitting body 42, for example, on its fitting tube 44. Generally, the deformation on the fitting body 42 may be substantially less than the deformation on the fitting jacket 50, for example, such that the deformation on the fitting body 42 is one or more orders of magnitude less than the deformation on the fitting jacket 50.

Nevertheless, since, as described above, a pipe segment 20 may be sealed in a pipe fitting 18 via engagement of the tubing 22 of the pipe segment 20 with a fitting seal 52 implemented on an outer surface of its fitting body 42, in some embodiments, the deformation of the fitting body 42 due to previous swaging may potentially affect (e.g., reduce) the integrity of a subsequent seal formed between the fitting seal 52 and pipe segment tubing 22. To facilitate improving, in some embodiments, one or more fitting seals 52 of the re-deployable pipe fitting 82 may be replaced before the re-deployable pipe fitting 82 is re-secured to pipe segment tubing 22, for example, at least in part by removing an old (e.g., used) fitting seal 52 from a corresponding seal cavity on the reusable fitting body 85 and disposing a new fitting seal 52 in the seal cavity (process block 144). In particular, to facilitate compensating for deformation of the reusable fitting body 85, in some embodiments, a fitting seal 52 of the re-deployable pipe fitting 82 may be replaced with a thicker fitting seal 52.

In this manner, the techniques described in the present disclosure may facilitate implementing a pipe fitting that is at least partially reusable and/or re-deployable in a pipeline system, which, at least in some instances, may facilitate improving pipeline deployment efficiency. In particular, at least in some instances, re-deploying a previously deployed (e.g., swaged) pipe fitting may obviate deployment of a new (e.g., not previously swaged) pipe fitting and, thus, facilitate reducing the number of new (e.g., not previously swaged) pipe fittings deployed in a pipeline system. Moreover, in some embodiments, implementing a fitting body in accordance with the techniques described in the present disclosure may enable the same fitting body to be used with pipe segments having varying tubing thicknesses. For example, in such embodiments, a first threaded fitting jacket, which has a larger inner surface diameter, may be coupled to the fitting body to accommodate thicker pipe segment tubing whereas a second threaded fitting jacket, which has a smaller inner surface diameter, may be coupled to the fitting body to accommodate thicker pipe segment tubing. As such, at least in some instances, reusing a fitting body design for multiple different tubing thickness may facilitate reducing the number of different fitting body types deployed in a pipeline system and, thus, improving pipeline deployment efficiency.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

1. A pipeline system comprising:
one or more pipe segments, wherein each pipe segment of the one or more pipe segments comprises tubing that defines a pipe bore and a fluid conduit implemented in an annulus of the tubing; and
a re-deployable pipe fitting configured to be secured to the one or more pipe segments, wherein the re-deployable pipe fitting comprises:
a fitting body comprising:
a fitting tube that defines a fitting bore through the re-deployable pipe fitting; and
a grab ring disposed around the fitting tube, wherein the fitting body comprises body threading implemented circumferentially along an outer surface of the grab ring; and
a threaded fitting jacket configured to be deformed around the tubing of a pipe segment of the one or more pipe segments to facilitate securing the re-deployable pipe fitting to the pipe segment, wherein the re-deployable pipe fitting comprises jacket threading that is implemented circumferentially along an inner surface of the threaded fitting jacket and configured to matingly engage with the body threading on the grab ring to enable the threaded fitting jacket to be coupled to the fitting body, removed from the fitting body, or both without using hot tooling.

2. The pipeline system of claim 1, wherein:
the threaded fitting jacket is configured to be coupled to the fitting body at least in part by actuating the threaded fitting jacket in a first direction relative to the fitting body; and
the threaded fitting jacket is configured to be removed from the fitting body at least in part by actuating the threaded fitting jacket in a second direction relative to the fitting body that is opposite the first direction.

3. (canceled)

4. The pipeline system of claim 1, wherein the re-deployable pipe fitting comprises another threaded fitting jacket configured to be deformed around other tubing of another pipe segment of the one or more pipe segments to facilitate securing the re-deployable pipe fitting to the other pipe segment, wherein:
the fitting body of the re-deployable pipe fitting comprises other body threading implemented circumferentially along the outer surface of the grab ring; and
the re-deployable pipe fitting comprises other jacket threading that is implemented circumferentially along another inner surface of the other threaded fitting jacket and configured to matingly engage with the other body threading on the grab ring to enable the other threaded fitting jacket to be coupled to the fitting body, removed from the fitting body, or both without using hot tooling.

5. (canceled)

6. The pipeline system of claim 1, wherein the re-deployable pipe fitting is configured to be re-secured to a different pipe segment of the one or more pipe segments at least in part by:
removing the threaded fitting jacket that has been deformed around the tubing of the pipe segment from the fitting body without using hot tooling; and
coupling a different fitting jacket that has not been previously deformed to the fitting body without using hot tooling.

7-16. (canceled)

17. A pipe fitting comprising:
a reusable fitting body, wherein the reusable fitting body comprises:
a fitting tube that defines a fitting bore configured to be fluidly coupled to a pipe bore defined by tubing of a pipe segment to be secured to the pipe fitting; and
a threaded grab ring implemented circumferentially around the fitting tube, wherein the reusable fitting body comprises body threading implemented circumferentially along an outer surface of the threaded grab ring; and
a threaded fitting jacket comprising jacket threading, wherein the jacket threading is implemented circumferentially along an inner surface of the threaded fitting jacket and configured to matingly engage with the body threading on the threaded grab ring to enable the threaded fitting jacket to be connected to the reusable fitting body, disconnected from the reusable fitting body, or both at least in part by rotationally actuating a portion of the pipe fitting.

18. The pipe fitting of claim 17, comprising another threaded fitting jacket, wherein:
the reusable fitting body comprises other body threading implemented circumferentially along the outer surface of the threaded grab ring; and
the other threaded fitting jacket comprises other jacket threading, wherein the other jacket threading is implemented circumferentially along another inner surface of the other threaded fitting jacket and configured to matingly engage with the other body threading on the threaded grab ring to enable the other threaded fitting jacket to be connected to the reusable fitting body, disconnected from the reusable fitting body, or both at least in part by rotationally actuating the portion of the pipe fitting.

19. The pipe fitting of claim 17, wherein the threaded fitting jacket is configured to be:
connected to the reusable fitting body at least in part by rotationally actuating the threaded fitting jacket in a first direction relative to the reusable fitting body; and
disconnected from the reusable fitting body at least in part by rotationally actuating the threaded fitting jacket in a second direction relative to the reusable fitting body that is opposite the first direction.

20. (canceled)
